(19) United States
(12) Patent Application Publication
(10) Pub. No.: US 2021/0337041 A1
(43) Pub. Date: Oct. 28, 2021

(54) ORCHESTRATED PROXY SERVICE

(71) Applicant: Microsoft Technology Licensing, LLC, Redmond, WA (US)

(72) Inventors: Guy Lewin, New York City, NY (US); Vitaly Khait, Yavne (IL); Yossi Haber, Ganei Tikva (IL)

(73) Assignee: Microsoft Technology Licensing, LLC, Redmond, WA (US)

(21) Appl. No.: 16/859,548

(22) Filed: Apr. 27, 2020

(51) Int. Cl. H04L 29/08

(52) U.S. Cl. CPC H04L 67/28

(57) ABSTRACT

An example proxy server is disclosed. The proxy server includes a plurality of services to process a received network message. Proxy services applicable to the received network message are determined. The applicable proxy services are selected from the plurality of proxy services. The network message is routed to the applicable proxy services for processing.

### BACKGROUND

A proxy service or proxy server is a server application or device that provides an intermediary between a client, such as a user agent, that seeks a resource from a server that provides the resource. Clients and servers can direct computer network traffic through a proxy server rather than directly between the client and server. For example, a client generates a request via a user agent such as a web browser. If a proxy server is employed, the request is provided to the proxy server, and the proxy server makes the request to the server on behalf of the client. The proxy server also collects the response from the server, and forwards the response to the client. In some examples, the proxy server can also change data being passed between the client and server and filter the traffic. Proxy servers may be categorized as forward proxies or reverse proxies. A forward proxy provides services to a client or a group of clients such as a gateway or tunneling. Forward proxies may store and forward internet services to reduce and control network traffic and can be used to alter or hide Internet Protocol (IP) addresses. A reverse proxy can hide the identity of a server and for load balancing, authentication, decryption, and caching.

### SUMMARY

This summary is provided to introduce a selection of concepts in a simplified form that are further described below in the Description. This summary is not intended to identify key features or essential features of the claimed subject matter, nor is it intended to be used to limit the scope of the claimed subject matter.

An example proxy server is disclosed. The proxy server includes a plurality of services to process a received network message. Proxy services applicable to the received network message are determined. The applicable proxy services are selected from the plurality of proxy services. The network message is routed to the applicable proxy services for processing. In one example, the proxy server includes an orchestrator and a plurality of services. The orchestrator routes the network message to the applicable services. In one example, the proxy server can be included in a network environment to route communications between a client device and a content server, and the communications can be in the form of web traffic. For instance, the message can be an HTTP request message from the client device to the content server or an HTTP response message from the content server to the client device. In one example, the proxy server can be included as part of a security service, such as a cloud access security broker and be configured as a forward proxy or a reverse proxy.

The proxy server can be implemented as a plurality of modules or services, in which each service can be deployed, maintained, and scaled without affecting the other services. Further, the messages are routed to the relevant services such as the services applicable to the message, rather than through all of the services if less than all of the services are applicable to the message. For example, the message may skip or avoid services of the set of plurality of services dynamically. In one example, the proxy services of the plurality of proxy services are loosely coupled to each other and not included in a monolithic set of the plurality of proxy services. For instance, each of the proxy services of plurality of proxy services is included in a separately scalable, maintainable module such as a container. The proxy services of the plurality of proxy services can be scaled, maintained, and built independently of each other

### BRIEF DESCRIPTION OF THE DRAWINGS

The accompanying drawings are included to provide a further understanding of embodiments and are incorporated in and constitute a part of this disclosure. The drawings illustrate embodiments and together with the description serve to explain principles of embodiments. Other embodiments and many of the intended advantages of embodiments will be readily appreciated, as they become better understood by reference to the following description. The elements of the drawings are not necessarily to scale relative to each other. Like reference numerals designate corresponding similar parts.

FIG. 1 is a block diagram illustrating an example of a computing device, which can be configured in a computer network.

FIG. 2 is a schematic diagram illustrating an example computer network having an example orchestrated proxy service of the disclosure, which can be configured on the example computing device of FIG. 1.

FIG. 3 is a schematic diagram illustrating the example orchestrated proxy service of FIG. 2.

FIG. 4 is a block diagram illustrating an example method of the orchestrated proxy service of FIG. 3.

### DESCRIPTION

In the following Description, reference is made to the accompanying drawings, which form a part hereof, and in which is shown by way of illustration specific embodiments in which the invention may be practiced. It is to be understood that other embodiments may be utilized and structural or logical changes may be made without departing from the scope of the present invention. The following description, therefore, is not to be taken in a limiting sense. It is to be understood that features of the various example embodiments described herein may be combined, in part or whole, with each other, unless specifically noted otherwise.

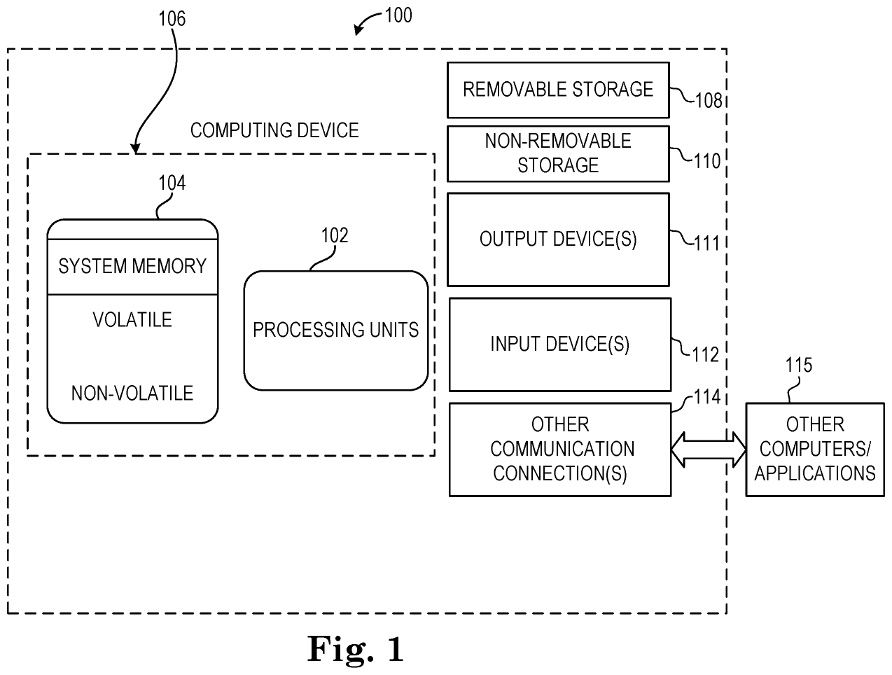

FIG. 1 illustrates an exemplary computer system that can be employed in an operating environment and used to host or run a computer application included on one or more computer readable storage mediums storing computer executable instructions for controlling the computer system, such as a computing device, to perform a process. The exemplary computer system includes a computing device, such as computing device 100. The computing device 100 can take one or more of several forms. Such forms include a tablet, a personal computer, a workstation, a server, a handheld device, a consumer electronic device (such as a video game console or a digital video recorder), or other, and can be a stand-alone device or configured as part of a computer network.

In a basic hardware configuration, computing device 100 typically includes a processor system having one or more processing units, i.e., processors 102, and memory 104. By way of example, the processing units may include two or more processing cores on a chip or two or more processor chips. In some examples, the computing device can also have one or more additional processing or specialized processors (not shown), such as a graphics processor for general-purpose computing on graphics processor units, to perform processing functions offloaded from the processor 102. The memory 104 may be arranged in a hierarchy and may include one or more levels of cache. Depending on the configuration and type of computing device, memory 104 may be volatile (such as random access memory (RAM)), nonvolatile (such as read only memory (ROM), flash memory, etc.), or some combination of the two.

Computing device 100 can also have additional features or functionality. For example, computing device 100 may also include additional storage. Such storage may be removable or non-removable and can include magnetic or optical disks, solid-state memory, or flash storage devices such as removable storage 108 and non-removable storage 110. Computer storage media includes volatile and nonvolatile, removable and non-removable media implemented in any suitable method or technology for storage of information such as computer readable instructions, data structures, program modules or other data. Memory 104, removable storage 108 and non-removable storage 110 are all examples of computer storage media. Computer storage media includes RAM, ROM, EEPROM, flash memory or other memory technology, CD-ROM, digital versatile discs (DVD) or other optical storage, magnetic cassettes, magnetic tape, magnetic disk storage or other magnetic storage devices, universal serial bus (USB) flash drive, flash memory card, or other flash storage devices, or any other storage medium that can be used to store the desired information and that can be accessed by computing device 100. Accordingly, a propagating signal by itself does not qualify as storage media. Any such computer storage media may be part of computing device 100.

Computing device 100 often includes one or more input and/or output connections, such as USB connections, display ports, proprietary connections, and others to connect to various devices to provide inputs and outputs to the computing device. Input devices 112 may include devices such as keyboard, pointing device (e.g., mouse, track pad), stylus, voice input device, touch input device (e.g., touchscreen), or other. Output devices 111 may include devices such as a display, speakers, printer, or the like.

Computing device 100 often includes one or more communication connections 114 that allow computing device 100 to communicate with other computers/applications 115. Example communication connections can include an Ethernet interface, a wireless interface, a bus interface, a storage area network interface, and a proprietary interface. The communication connections can be used to couple the computing device 100 to a computer network, which can be classified according to a wide variety of characteristics such as topology, connection method, and scale. A network is a collection of computing devices and possibly other devices interconnected by communications channels that facilitate communications and allows sharing of resources and information among interconnected devices. Examples of computer networks include a local area network, a wide area network, the internet, or other network.

In one example, one or more of computing device 100 can be configured as a client device for a user in the network. The client device can be configured to establish a remote connection with a server on a network in a computing environment. The client device can be configured to run applications or software such as operating systems, web browsers, cloud access agents, terminal emulators, or utilities. In one example, the client device can also be configured to further include a server application.

In one example, one or more of computing device 100 can be configured as a server in the network such as a server device. The server can be configured to establish a remote connection with the client device in a computing network or computing environment. The server can be configured to run application or software such as operating systems.

In one example, one or more of computing devices 100 can be configured as servers in a datacenter to provide distributed computing services such as cloud computing services. A data center can provide pooled resources on which customers or tenants can dynamically provision and scale applications as needed without having to add servers or additional networking. The datacenter can be configured to communicate with local computing devices such used by cloud consumers including personal computers, mobile devices, embedded systems, or other computing devices. Within the data center, computing device 100 can be configured as servers, either as stand alone devices or individual blades in a rack of one or more other server devices. One or more host processors, such as processors 102, as well as other components including memory 104 and storage 110, on each server run a host operating system that can support multiple virtual machines. A tenant may initially use one virtual machine on a server to run an application. The datacenter may activate additional virtual machines on a server or other servers when demand increases, and the datacenter may deactivate virtual machines as demand drops.

Datacenter may be an on-premises, private system that provides services to a single enterprise user or may be a publicly (or semi-publicly) accessible distributed system that provides services to multiple, possibly unrelated customers and tenants, or may be a combination of both. Further, a datacenter may be a contained within a single geographic location or may be distributed to multiple locations across the globe and provide redundancy and disaster recovery capabilities. For example, the datacenter may designate one virtual machine on a server as the primary location for a tenant's application and may activate another virtual machine on the same or another server as the secondary or back-up in case the first virtual machine or server fails.

A cloud-computing environment is generally implemented in one or more recognized models to run in one or more network-connected datacenters. A private cloud deployment model includes an infrastructure operated solely for an organization whether it is managed internally or by a third-party and whether it is hosted on premises of the organization or some remote off-premises location. An example of a private cloud includes a self-run datacenter. A public cloud deployment model includes an infrastructure made available to the general public or a large section of the public such as an industry group and run by an organization offering cloud services. A community cloud is shared by several organizations and supports a particular community of organizations with common concerns such as jurisdiction, compliance, or security. Deployment models generally include similar cloud architectures, but may include specific features addressing specific considerations such as security in shared cloud models.

Cloud-computing providers generally offer services for the cloud-computing environment as a service model provided as one or more of an infrastructure as a service, platform as a service, and other services including software as a service. Cloud-computing providers can provide services via a subscription to tenants or consumers. For example, software as a service providers offer software applications as a subscription service that are generally accessible from web browsers or other thin-client interfaces, and consumers do not load the applications on the local computing devices. Infrastructure as a service providers offer consumers the capability to provision processing, storage, networks, and other fundamental computing resources where the consumer is able to deploy and run software, which can include operating systems and applications. The consumer generally does not manage the underlying cloud infrastructure, but generally retains control over the computing platform and applications that run on the platform. Platform as a service providers offer the capability for a consumer to deploy onto the cloud infrastructure consumer-created or acquired applications created using programming languages, libraries, services, and tools supported by the provider. In some examples, the consumer does not manage or control the underlying cloud infrastructure including network, servers, operating systems, or storage, but has control over the deployed applications and possibly configuration settings for the application-hosting environment. In other examples, the provider can offer a combination of infrastructure and platform services to allow a consumer to manage or control the deployed applications as well as the underlying cloud infrastructure. Platform as a service providers can include infrastructure, such as servers, storage, and networking, and also middleware, development tools, business intelligence services, database management services, and more, and can be configured to support the features of the application lifecycle including one or more of building, testing, deploying, managing, and updating.

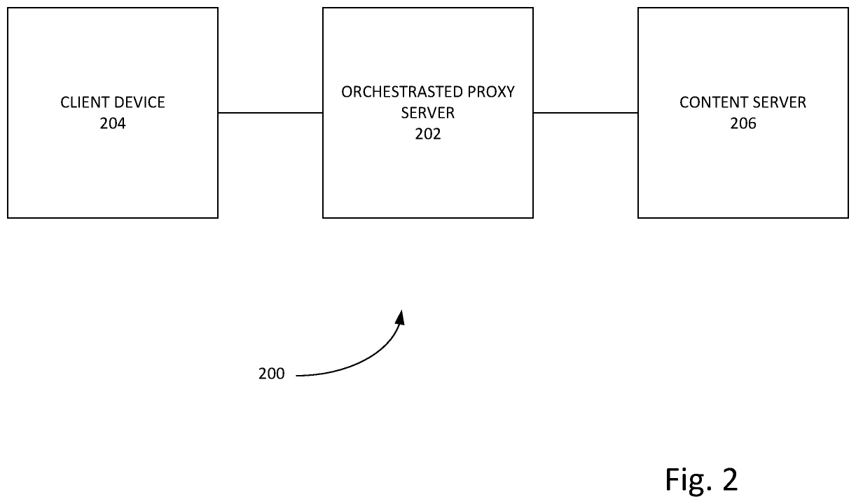

FIG. 2 illustrates an example computer network 200 including an orchestrated proxy server 202 in which the computer network 200 illustrates an example environment for the orchestrated proxy server 202. The computer network 200 includes including a user device, such as a client device 204 in a client-server architecture, coupled to the proxy server 202. The computer network 200 further includes a network resource such as a content server 206 coupled to the proxy server 202, and operably coupled to the client device 204 for communication with the client device 204. For example, the client device 204 can communicate requests to the content server 206 via the orchestrated proxy server 202, the content server 206 may communicate responses to the requests to the client device 204 via the proxy server. The content server 206 may include at least one of a variety of network resources such as mail servers and web servers that may be accessed via the computer network 200 by user device 202. The client device 202 may run an application such as a client agent to access resources on the content server 206. Examples of client agents include web browsers, dedicated communication applications, and mobile applications. In one example, the server 206 is configured as an origin server configured to listen for and process incoming requests. In some examples, the content server 206 may be configured as an edge server that can cache static resources from an origin server. In one example, the orchestrated proxy server 202 is configured as a forward proxy server, which, in one example, can act on behalf of the client device 204, such as a plurality of client devices 204. For instance, a forward proxy is disposed in front of the client device 202. In another example, the orchestrated proxy server 202 is configured as a reverse proxy server, which, in one example, can act on behalf of the content server 206, such as a plurality of content servers 206.

In one example, the proxy server 202 can be incorporated into a security service, such as a security service for an enterprise. In some examples, the security service can be deployed in a cloud environment. The security service can be configured as a forward proxy such as a firewall to protect client devices from malicious sites. Also, or additionally, the security service can be configured as a reverse proxy to enforce conditional access controls to available services based on policies of the enterprise. For example, users of the enterprise are directed through the security service before accessing subscriptions of third-party cloud applications. An example of such a security service can be available under the trade designation Microsoft Cloud App Security Cloud Access App Control or Microsoft Account, both from Microsoft, Inc., of Redmond, Wash.

The client device 204 and content server 206 may be configured in a communication or network session through the orchestrated proxy server 202. For example, the session is a temporary and interactive information exchange between the client device 204 and the content server 206. The client device 204 and server 206 may employ a request-response protocol such as hypertext transfer protocol, or HTTP in which the client device 204 submits an HTTP request message to the content server 206, and the server 206, which can provide resources such as hypertext markup language, or HTML files and other content, returns a response message to the client device 204. During an HTTP session, the client device 204 initiates a request by establishing a connection, such as transmission control protocol, or TCP connection to a port the content server 206. An HTTP server listening on that port waits for a request message from the client device 204. Upon receiving a request, the content server 206 can send back to the client device 204 a response message that may include a requested resource.

After connection is established, the client device 204 can send the request such as via the client agent. A request can include text directives. For example, a line of the request can include a method followed by parameters such as a path of the document and a protocol version. The request can also provide a header or headers in a block, which may provide information to the server with information of the type of data that is appropriate. An optional data block may also be included in the request as a request message body. HTTP defines a set of request methods that indicate the desired action to be performed on the resource that may be included in the request. An HTTP request message thus can include a request line, a header, and a request message body. The content server 206 can process the request and return a response. Similar to the request, the response is a set of text directives that may include three blocks. A status line can include an acknowledgement of the HTTP version used and a status request. The response may also include a header or block of headers that provide information about the data sent in the request. Further, the response may include a data block that includes data sent to the client device 204 as a response message body. HTTP defines a set of response status codes that indicate the status of the response, which may be included in the response. An HTTP response message thus can include a status line, a header, and a response message body.

Depending on the number and types of requests and responses, HTTP proxy servers may be called upon to process a relatively large amount of traffic. Proxy servers have traditionally been developed and implemented as a single executable with many modes and steps for efficiency. Such implementations of proxy servers, however, make difficult the maintenance of proxy servers and the deployment of proxy servers as microservices. For example, change cycles are coupled together in which a small change in an aspect of the proxy server amounts to a rebuild or redeployment of the entire proxy server. Further, scaling of the proxy server can include scaling of the entire proxy server rather than aspects that call for more resource. One approach to addressing the issues of a monolithic proxy server includes separating the proxy server into a set of proxy services that are chained together. Services can be individually maintained and scaled. Unfortunately, chaining proxy services is rife with inefficiencies for the session. Communications pass from service to service regardless of whether the service is application in the communication. For instance, large parts of the session, such as the request and response bodies, are passed from service to service regardless of whether the service is applicable to the parts of the session.

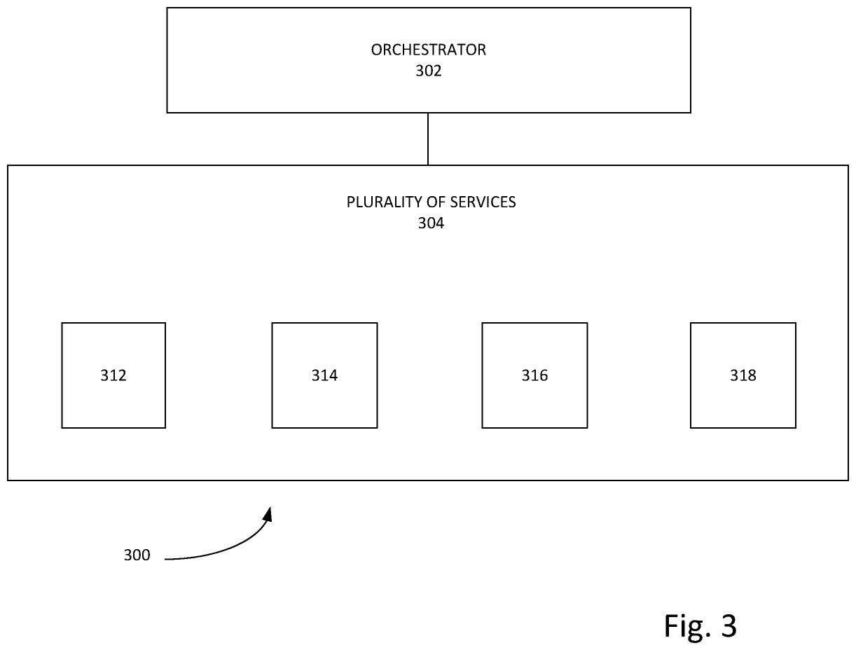

FIG. 3 illustrates an example orchestrated proxy server 300, which may be implemented in the computer network 200 as the orchestrated proxy server 202. The orchestrated proxy server 300 can be implemented as a plurality of modules or services, in which each service can be deployed, maintained, and scaled without affecting the other services. Further, the traffic in the form of request messages and response messages, or messages, are routed to the relevant services such as the services applicable to the message, rather than through all of the services if less than all of the services are applicable to the message. For example, the message may skip or avoid services of the set of plurality of services dynamically.

The example orchestrated proxy server 300 includes an orchestrator 302 and a plurality of proxy services 304 such as a set of services. The orchestrated proxy server 300 is configured to receive a message, such as an HTTP request message or an HTTP response message for a network device such as the client device 204 or the content server 206. The orchestrated server 300 passes the message to the orchestrator 302, and the orchestrator can determine what subset of services of the plurality of services 304 is applicable to the message. The message is passed to the subset of services of the plurality of services 304, or applicable services, and the message is processed at the applicable services, which is less than all the services of the plurality of services 304. The message is then passed to the network device. In one example, the plurality of services can include two services. For instance, one service can process request messages and the other service can process response message. A message received at the orchestrated proxy server 300 is passed to the orchestrator 302, which determines whether the request message services or the response message service of the plurality of services 304 is the applicable service to the message. The message is passed to the applicable service, and the message is passed to less than all of the plurality of services 304. After the message is processed by the applicable service, the message is passed to the network device.

In one example, the proxy services of the plurality of proxy services 304 are loosely coupled to each other and not included in a monolithic set of the plurality of proxy services. For instance, each of the proxy services of plurality of proxy services is included in a separately scalable, maintainable module such as a container. The proxy services of the plurality of proxy services 304 can be scaled, maintained, and built independently of each other.

The illustrated example includes a request header service 312, request body service 314, a response header service 316, and a response body service 318 in the plurality of services 304. The request header service 312 is applicable to process the header of an HTTP request message received from the client device 204 and intended for the content server 206. The request header body 314 is applicable to process the body portion of the HTTP request message received from the client device 204 and intended for the content server 206. The response header service 316 is applicable to process the header of an HTTP response message received from the content server 206 and intended for the client device 204. The response body service 318 is applicable to process the body of the HTTP response message received from the content server 206 and intended for the client device 204. In one example, the applicable services for a message, such as the request header service 312 and the request body service 314 for a request message or the response header service 316 and the response body service 318 for a response message, may be applied concurrently or in series or other combination. The orchestrator 302 determines which of the services 312, 314, 316, 318 of the plurality of services 304 are applicable to the message, and routes the message through the applicable services in which the applicable services 312, 314, 316, or 318 are less than the plurality of services 304.

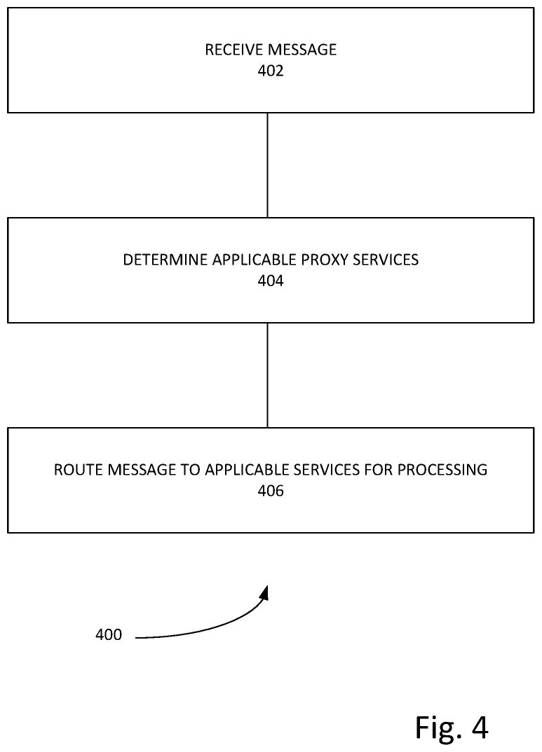

FIG. 4 illustrates an example method 400 that can be used by the orchestrated proxy server 300. A proxy server comprising a plurality of proxy services receives a network message at 402. The network message is directed between a client device 204 and a content server 206. In one example, the network message is an HTTP message, such as an HTTP request message and an HTTP response message. The received network message is provided to an orchestrator 302, which processes the message. The orchestrator of the proxy server determines which of the plurality of proxy services is applicable to the received network message as applicable proxy services at 404. In one example, the applicable proxy services corresponding with the received message are less than the plurality of proxy services. The received message is routed to the applicable proxy services for processing at 406. In the example, the received message is routed, such as dynamically routed by the orchestrator 302, to less than the plurality of proxy services 304 for processing. In one instance, the received message is routed to one applicable proxy service of the plurality of proxy services 304.

The plurality of services 304 can include services to process portions of message. For example, the plurality of services can include separate service to correspondingly process a start line, headers, and a body portion of each message received. In one example, the services can be directed to separately processing a request message and a response message. For instance, the plurality of services can include a request header service 312, request body service 314, a response header service 316, and a response body service 318 in the plurality of services 304. Additionally, the services can be directed to processing binary frames. Other example division of services are contemplated.

In the example of orchestrated proxy server 300, the orchestrated proxy server 300 receives the message at an input module and provides the message to the orchestrator 302, which can be configured as a module. The orchestrated proxy server 300 can determine the aspects of the message, such as whether the message is an HTTP message, a request message, a response message. In one example, the aspects of the message can be determined with the orchestrator 302, and in another example, the aspects of the message can be determined with a service such as an input module prior to passing the message to the orchestrator 302. The orchestrator determines which of the plurality of services 304, such as services 312, 314, 316, 318, are applicable to the received message, and routes the message to the applicable services. For example, a response message with a body can be routed to the response header service 316 and response body service 318. The response message is not routed to the request header service 312 and the request body service 314. In another example, the orchestrator determines that a request message without a body is to be routed to the request header service 312 but is not routed to the request body service 314, response header service 316, and the response body service 318.

The example orchestrated proxy server 300 and method 400 can be implemented to include a combination of one or more hardware devices and computer programs for controlling a system, such as a computing system having a processor 102 and memory 104, to perform method 400. For instance, orchestrated proxy server 300 and method 400 can be implemented as a computer readable medium or computer readable storage device having set of executable instructions for controlling the processor 102 to perform the method 400. The orchestrated proxy server 300 and method 400 can be included as a service in a cloud environment, such as a security service implementing a cloud access security broker to enforce security polices, and implemented on a computing device 100 in a datacenter as an orchestrated proxy server, such as an orchestrated forward proxy server or an orchestrated reverse proxy server, to direct web traffic between a client device 204 and a content server 206.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein.

What is claimed is:

1. A method for use with a proxy server, the method comprising:
determining applicable proxy services of a received network message, the applicable proxy services selected from a plurality of proxy services; and
routing the network message to the applicable proxy services for processing.

2. The method of claim 1 wherein the network message is an HTTP (hypertext transfer protocol) message.

3. The method of claim 1 wherein the HTTP message is one of a request message and a response message.

4. The method of claim 1 wherein the applicable proxy services are less than the plurality of proxy service.

5. The method of claim 4 wherein the applicable proxy services are one proxy service.

6. The method of claim 1 wherein the plurality of proxy services include a request message proxy service and response message proxy service.

7. The method of claim 6 wherein the request message proxy service includes a request message header proxy service and a request body message proxy service, and a request message proxy service is processed via the request proxy service.

8. The method of claim 7 wherein the request message is not processed via the response message proxy service.

9. The method of claim 6 wherein the response message proxy service includes a response message header proxy service and a response body message proxy service, and a response message proxy service is processed via the request proxy service.

10. The method of claim 9 wherein the response message is not processed via the request message proxy service.

11. A computer readable storage device to store computer executable instructions to control a processor to:
determine applicable proxy services of a received network message, the applicable proxy services selected from a plurality of proxy services; and
route the network message to the applicable proxy services for processing.

12. The computer readable storage device of claim 11 wherein the services of the plurality of services are independently scalable.

13. The computer readable storage device of claim 11 wherein network message is one of an HTTP request message and an HTTP response message.

14. The computer readable storage device of claim 11 wherein the applicable proxy services are less than the plurality of proxy service.

15. A proxy server system, comprising:
a memory device to store a set of instructions; and
a processor to execute the set of instructions to:
determine applicable proxy services of a received network message, the applicable proxy services selected from a plurality of proxy services; and
route the network message to the applicable proxy services for processing.

16. The proxy server system of claim 15 configured as a forward proxy.

17. The proxy server system of claim 15 configured as a reverse proxy.

18. The proxy server system of claim 15 included in a security service.

19. The proxy server system of claim 15 wherein the security service is a cloud access security broker.

20. The proxy server system of claim 15 wherein the proxy server system directs web traffic between a client device and a content server.
